(19) United States
(12) Patent Application Publication
(10) Pub. No.: US 2010/0043421 A1
(43) Pub. Date: Feb. 25, 2010

(54) METHOD FOR OPERATING A HYDRAULIC SYSTEM, AND HYDRAULIC SYSTEM

(76) Inventor: Winfried Rüb, Waldshut-Tiengen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/312,470

(22) PCT Filed: Oct. 11, 2007
(86) PCT No.: PCT/EP2007/008831

§ 371 Date: May 12, 2009

(30) Foreign Application Priority Data
Dec. 7, 2006 (DE) 10 2006 057 699.3

(51) Int. Cl. F16D 31/02

(52) U.S. Cl. 60/421

(57) ABSTRACT

A method for operating a hydraulic system having at least one supply device, in particular a hydraulic pump (39)), which supplies different hydraulic consumers is characterized in that a synchronizing device (33, 35) ensures that, if at least one hydraulic consumer is not supplied sufficiently, the deficit in volumetric flow for said consumer is compensated for in such a way that all the consumers compensate for the deficit equally.

The invention relates to a method for operating a hydraulic system having at least one supply device, in particular a hydraulic pump, which supplies different hydraulic consumers. Moreover, the invention relates to a hydraulic system which can be operated as specified in the method according to the invention.

In motor-driven systems and devices with hydraulic systems, for example, in loader-like and excavator-like construction machinery, for reasons of costs it is typically necessary to design the output of the diesel engine which is used to drive the hydraulic pump without reserves. Likewise, for reasons of costs, in many cases the hydraulic pump is also not designed such that with a simultaneously maximum volumetric flow demand of all consumers, sufficient supply of all consumers would be ensured.

In working operation this leads to the diesel engine being operated at its output limit on the one hand and, on the other, the pump flow rate in parallel operation of hydraulic consumers not being sufficient for the desired maximum working speeds. It therefore becomes necessary to use for safety functions priority valves which supply the preferred consumers first before delivery to other consumers is released. All other consumer must share the remaining flow.

For machines such as the aforementioned construction machinery, it is prior art to supply the consumers by way of directional control valves with compensators connected upstream, the valve spools of the directional control valves determining the size of the opening of the metering orifices for supply of the consumers. Viewed from the pump, a series of variously high resistances is presented by the operating principle of the upstream compensators which copy the pressure of the external loads to upstream from the metering orifices and still increase it by the amount of force of their control spring. When the flow rate of the pump is insufficient, the pump pressure collapses and the working medium flows over the path of least resistance. The consumer with the highest load can thus be shut down. Its “saved” volumetric flow is thus available to all other consumers.

For the machine operator this system behavior is not acceptable since for typical machine control with a joystick, several functions are run at the same time. If one consumer inadvertently stops, the operator will experience difficulties with the controls.

The attempt to solve this problem by. using valves with compensators connected downstream from the metering orifice does not lead to the desired success, even though downstream compensators do not copy the load pressure to upstream from the metering orifice, but the highest load pressure in the system to downstream from the metering orifice, as a result of which, when the pump pressure collapses, all resistances remain the same viewed from the pump, disadvantageously in these systems, however, the amount upstream from the metering orifice must be separated; this is not easily possible. Another particular disadvantage is that the load signaling system of directional control valves with downstream compensators dictates a continuous discharge flow from the controlled volumetric flow of the consumer with the highest load; this constitutes an energy loss.

With respect to this problem, the object of the invention is to make available a method for operating a hydraulic system since it is characterized by relatively improved operating behavior when the supply device is overtaxed.

According to the invention this object is achieved by a method which has the features of claim 1 in its entirety.

Accordingly, the particularity of the invention is that when the consumer is undersupplied, all consumers in the hydraulic system are used to compensate for the volumetric flow deficit of the undersupplied consumer. While in the prior art in systems with an upstream compensator in the case of undersupply, the consumer with the highest load can shut down, whose saved volumetric flow then benefits the other consumers, the invention conversely calls for a correspondingly reduced volumetric flow to be made available. to all consumers in the case of undersupply. Therefore there is no danger that the machine operator who is controlling several consumers at the same time, in order to simultaneously run several functions, will be confronted with a situation in which one consumer is shut down while the other consumers continue to operate (remain in motion).

In embodiments in which a volumetric flow of pressurized fluid which is dependent on the size of the opening of an assigned adjustable metering orifice is supplied by way of the latter from a pump delivery flow to each consumer, on the orifices a pressure difference being produced which is referenced to the size of the orifice opening and the pump flow rate, preferably the procedure can be such that when the pressure difference drops on at least one metering orifice to below a setpoint, a correction signal is produced, depending on its signal value the size of the opening of all metering orifices is synchronously reduced, the correction signal being maintained until the setpoint of the pressure difference is reached again. The correction signal therefore is generated depending on the circumstance that when the hydraulic pump is overtaxed, its pump flow rate is no longer sufficient to produce the necessary dynamic pressure on the metering orifice of the consumer with the highest load, by which the pressure difference on this orifice drops below a specified setpoint.

Preferably, a synchronous pressure is produced in a synchronous channel as the correction signal. Since the correction signal is thus present in the form of a pressure signal, it is preferably caused to take effect directly in the valve system.

In especially preferred embodiments, the synchronous pressure is produced by way of a synchronous compensator which is supplied on the one hand with the pump pressure and on the other with the highest load pressure of the system plus the force of its control spring, and by way of which when its control pressure difference is not reached a pressure source is connected to the synchronous channel.

In embodiments in which the supply of the consumers is controlled by proportional directional control valves, whose valve spools can be triggered hydraulically for changing the metering orifices by sensor pressure, the synchronous pressure is supplied to the face side of the valve spools which is triggered with the sensor pressure. The synchronous pressure produced in operating states of undersupply therefore results in that the valve spools of all directional control valves are reset by an amount which depends on the synchronous pressure against the respective sensor pressure, and therefore all consumers are supplied with a correspondingly reduced volumetric flow for compensation of the undersupply.

In especially advantageous embodiments the pressure difference on the metering orifices of the directional control valves are controlled by an assigned individual compensator and the system pressure is controlled by a system compensator.

Accordingly, the differential pressure of the synchronous compensator is preferably set to a somewhat lower value than the differential pressure of the system compensator. This ensures that in normal operation of the system, the differential pressure in the system is definitively determined by the system compensator.

The pressure difference of the synchronous compensator is preferably set to the pressure difference of the individual compensators or higher.

In especially preferred embodiments, the system of valves and pumps is dimensioned such that at the maximum possible volumetric flow demand the maximum synchronous pressure does not exceed the pretensioning force of the centering springs of the valve spools. This ensures that in the case of undersupply of the system the valve spools cannot be reset to their neutral position by the synchronous pressure.

In systems with consumers which, for example for reasons of safety, are especially preferred, the supply of the correction system to the respectively preferred consumer can be stopped by way of a type of priority circuit.

The subject matter of the invention is also a hydraulic system which can be operated according to the method specified in one of claims 1 to 10 and which has the features a) to c) of claim 11.

Other features of the hydraulic system are given in the dependent claims 12 to 14.

The invention is detailed below using the drawings.

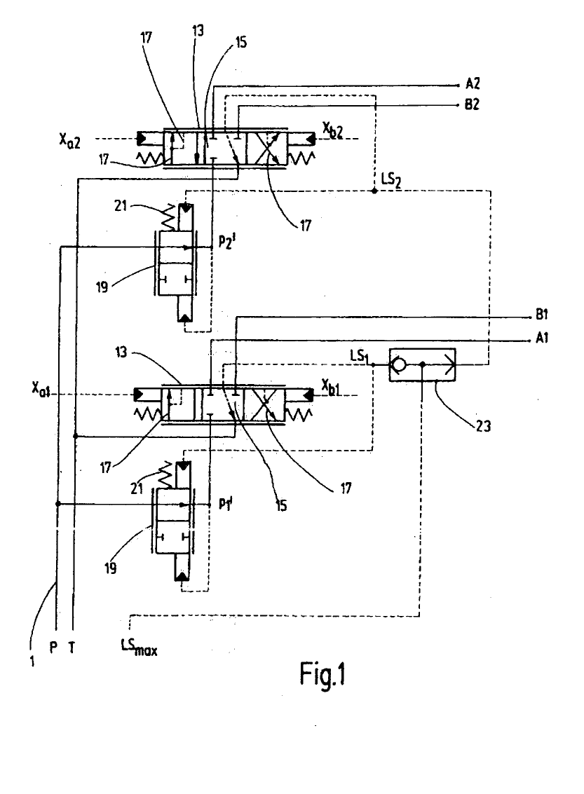

FIG. 1 shows a hydraulic circuit diagram of a hydraulic system which corresponds to the prior art for supply of two hydraulic consumers;

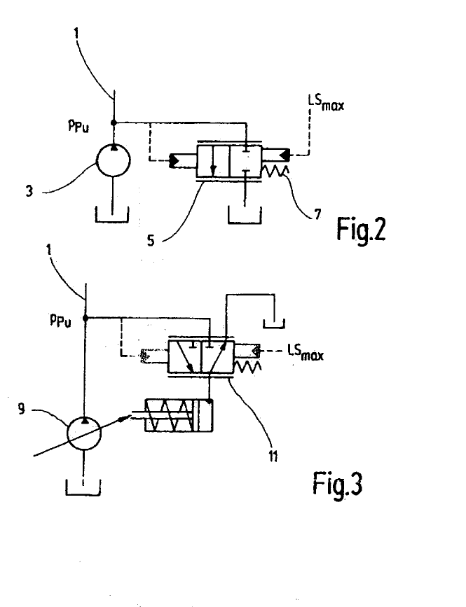

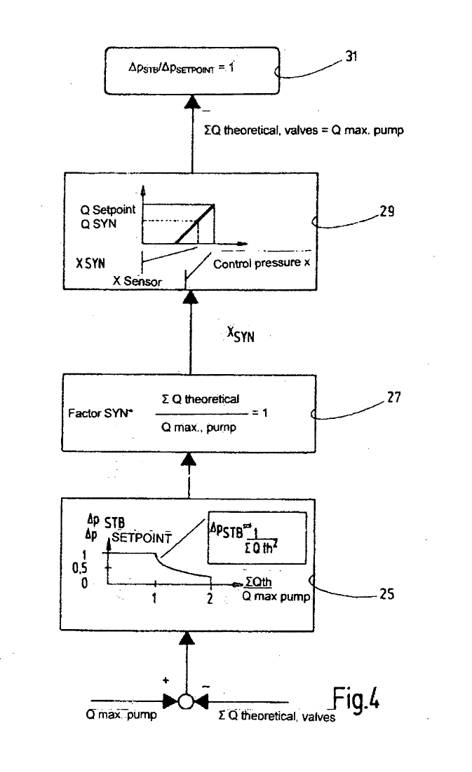

FIGS. 2 and 3 shows hydraulic circuit diagrams of two different system pressure regulators for use in hydraulic systems of the type shown in FIG. 1;

FIG. 4 shows a flow chart illustrating the operating principle of the invention;

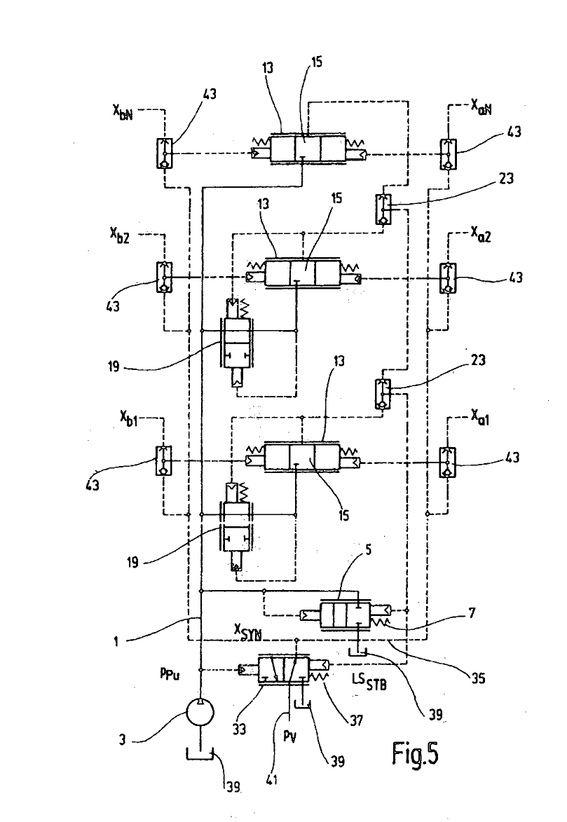

FIG. 5 shows a hydraulic circuit diagram similar to FIG. 1, but of the hydraulic system according to the invention which is designed for implementing the method according to the invention;

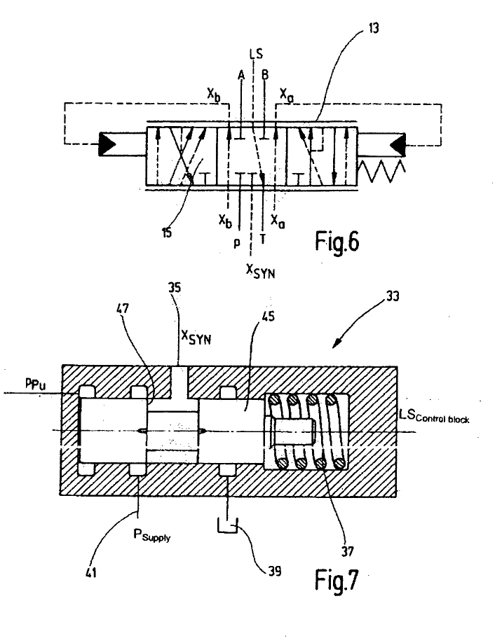

FIG. 6 shows the operating diagram of a directional control valve for the synchronous control method according to the invention and with a logic circuit for triggering with synchronous pressure, and FIG. 7 shows a schematically simplified cross section of a synchronous compensator.

In FIG. 1 which shows a hydraulic, system which corresponds to the prior art for supply of two consumers (not shown), a system pressure regulator which is connected upstream from the pump line 1 is omitted. FIGS. 2 and 3 show two embodiments of system pressure regulators which can be used for hydraulic systems of the type shown in FIG. 1 in order to keep constant the pressure difference of the pump pressure Pₚᵤ and the maximum load pressure LSmax. In FIG. 2 it is a hydraulic pump in the form of a constant delivery pump 3 whose pressure side is connected to a three-way compensator 5 which is supplied on the one hand with the pump pressure Pₚᵤ and on the other with LSmax, plus the force of one control spring 7, and which works like a pilot-controlled pressure limitation valve which keeps constant the pressure difference between the pump line 1 and LSmax. FIG. 3 conversely shows the use of a variable delivery pump 9 whose controller is formed by a directional control valve 11 which adjusts the required flow rate within the control circuit “pump adjustment mechanism.”

The supply of the consumers, which is not shown in FIG. 1, by way of the supply lines A1, B1 and A2, B2 takes place by way of proportional directional control valves 13 whose valve spools 15 with its metering edges define the size of the opening of metering orifices 17. One individual compensator 19 at a time is connected upstream from the directional control valves 13 which are supplied conventionally for upstream compensators on the one hand with the dynamic pressure p1′ and p2′ prevailing on the respective metering orifice 17 of the directional control valve 13, and on the other with the loading pressure of the pertinent consumer L_{S1} and LS₂ plus the force of its control spring 21. A selector valve 23 to which the load pressures LS₁ and LS₂ are supplied decides which load pressure is supplied as LSmax to the system pressure regulator which is not shown in FIG. 1. For controlling the volumetric flows which are supplied to the consumers by way of the supply lines A1, B1 and A2 and B2, the control valves 13 can be triggered hydraulically by a sensor pressure Xₐ₁ and Xₐ₂ being supplied to the face side of the valve spool 15 or a sensor pressure X_{b1} and X_{b2} being supplied to the opposite face side.

If the pump pressure collapses when the pump output is overtaxed during operation of the system shown in FIG. 1, on the individual compensator 19 with the highest load pressure only a reduced pressure difference as a pressure excess for controlling the pressure difference is available on the pertinent metering orifice 17. If this dynamic pressure on the most highly loaded directional control valve 13 drops to the load pressure or below, this consumer stops while the consumers under a low load continue to move.

FIG. 4 illustrates the state which is different from the latter and which arises by the method according to the invention. If the directional control valves 13 during system operation are opened to the extent that the pump flow rate is no longer sufficient to throttle the necessary dynamic pressure upstream from the metering orifices 17, the dynamic pressure then drops according to a quadratic function, see box 25 (first box from the bottom). In the next box 27 to the top, the control law of a synchronous compensator (33 in FIG. 5) provides for the volumetric flow demanded by the consumers to be reduced again down to the possible pump flow rate by the correction signal in the form of a synchronous pressure X_{syn} constituting compensation of the control pressures which prevail on the valve spools 15. The compensating synchronous pressure X_{syn} opposes the control pressures X, see box 29, and thus reduces the opening cross sections of all metering orifices 17. This takes place until the differential pressure setpoint which is set on the synchronous compensator 33 is reached again, see box 31.

FIG. 5 illustrates the method according to the invention using a hydraulic system with three-way directional control valves 13 for supplying three consumers, the supply lines being omitted and also the directional control valves 13 being shown simplified for the sake of clarity. Of the directional control valves 13, one individual compensator 19 in the same arrangement as shown in FIG. 1 is connected upstream from two of them, while the directional control valve 13 for the consumer N is integrated into the system without an individual compensator. The system pressure is regulated according to the example of FIG. 2 by a three-way compensator 5 which is connected to the pump line 1 at the output of the constant delivery pump 3.

The synchronous compensator 33 which is used to produce a synchronous pressure X_{syn} in a synchronous channel 35 is on the one hand supplied with the pump pressure Pₚᵤ and on the other hand with the maximum control block load pressure L_{STB} plus the force of a control spring 37. The choice of which load pressure is supplied as the maximum load pressure L_{STB} both to the synchronous compensator 33 and also to the system compensator 5 takes place as in the system of FIG. 1 by selector valves 23.

The synchronous compensator 33 works like the pump regulator in a control circuit in which the valve spools 15 of all directional control valves 13 participate. The basic principle is a sensor circuit which monitors the level of the current pressure difference on the control block (directional control valve 13). If this pressure difference is in the specified region, the synchronous compensator 33 remains passive, i.e., it is pressed by the desired pressure difference against its control spring 37 and relieves the synchronous channel 35 after the tank 39. In the other case, the synchronous compensator 33 assumes an open position and supplies from the supply line 41 the volumetric flow into the synchronous channel 35 in order to produce a synchronous pressure X_{syn}. The synchronous channel 35 can be connected in parallel to each face side of all valve spools 15, the decision—supply of control pressure/sensor pressure—being made by one selector valve 43 at a time to which on the one hand the sensor pressure X . . . on the one hand and the synchronous pressure X_{syn} on the other are supplied.

If the synchronous pressure X_{syn} rises and pushes through to the face side of the valve spool 15, it can be assumed that it is that side of the valve spool 15 which is opposite the side triggered with the sensor pressure. If, for example, a directional control valve 13 is triggered with 7 bar and delivers 50 l/min and at this point, the synchronous pressure rises from 0 to 2 bar, the spool 15 deflected with 7 bar is reset to the spool position corresponding to 5 bar control pressure by 2 bar counterpressure, as a result of which the volumetric flow supplied to the consumers is reduced. The corresponding applies to the valve spools 15 of the directional control valves 13 of the other consumers. The synchronous pressure is built up, i.e., the synchronous compensator 33 remains in the open position until the desired pressure difference on the control block has again reached the setpoint.

The differential pressure of the synchronous compensator 33 is set somewhat lower than the differential pressure of the system pressure regulator so that in normal saturated operation the differential pressure in the system is definitively determined by the system pressure regulator. The differential pressure of the individual compensators 19 is ideally set to the value of the pressure difference of the synchronous compensator 33. Then the synchronous compensator 33 recognizes incipient undersaturation of the system compensator 5, while the individual compensators 19 are still saturated. For incipient undersupply this does not cause any errors in synchronous control since, before the individual compensators 19 would completely open due to incipient undersaturation and then could no longer regulate, the synchronous compensator 33 already begins to produce a compensating synchronous pressure X_{syn} and thus to reset all deflected valve spools 15.

As alternatives to using the selector valves 43, according to FIG. 6, a logic circuit on the valve spool 15 of the directional control valves 13 can choose to what face side the sensor pressure or synchronous pressure is supplied.

FIG. 7 shows a cross section of the synchronous compensator 33 whose spool 45 is shifted so far to the left by the load pressure LS and the force of the control spring 37 in the figures that the metering edge 47 begins to connect the supply line 41 to the synchronous channel 35, while the connection to the tank 39 is cut off. When the pressure Pₚᵤ rises until the desired differential pressure is reached and the spool 45 is reset to the right, the synchronous channel 35 is relieved again to the tank 39.

If in this text orifices such as metering orifices are addressed, the pertinent details also apply to throttles such as metering throttles. These details also apply to the nozzles used.

1. A method for operating a hydraulic system having at least one supply device, in particular a hydraulic pump (39), which supplies different hydraulic consumers, characterized in that a synchronous device (33, 35) ensures that when at least one hydraulic consumer is undersupplied, the deficit in volumetric flow for this consumer is equalized such that all consumers equally compensate for the deficit.

2. The method according to claim 1, characterized in that a volumetric flow of pressurized fluid which is dependent on the size of the opening of an assigned adjustable metering orifice (17) is supplied by way of the latter from a pump delivery flow to each consumer, on the orifices (17) a pressure difference being produced which is referenced to the size of the orifice opening and the pump flow rate, and that when the pressure difference drops on at least one metering orifice (17) to below a setpoint, a correction signal (X_{syn}) is generated, depending on whose signal value the size of the opening of all metering orifices (17) is synchronously reduced, and that the correction signal is maintained until the setpoint of the pressure difference is reached again.

3. The method according to claim 2, characterized in that a synchronous pressure (X_{syn}) in a synchronous channel (35) is produced as the correction signal.

4. The method according to claim 3, characterized in that the synchronous pressure (X_{syn}) is produced by way of a synchronous compensator (33) which is supplied on the one hand with the pump pressure (Pₚᵤ) and on the other with the highest load pressure (L_{STB}) of the system, plus the force of its control spring (37), and by way of which when its control pressure difference is not reached, a pressure source (Pᵥ) is connected to the synchronous channel (35).

5. The method according to claim 4, characterized in that the supply of the consumers is controlled by proportional directional control valves (13) whose valve spools (15) can be triggered hydraulically for changing the metering orifices (17) by the sensor pressure (X . . . ), and that the synchronous pressure (X_{syn}) is supplied to the face side of the valve spools (15) which is not triggered with the sensor pressure (X . . . ).

6. The method according to claim 5, characterized in that the pressure difference on the metering orifices (17) of the directional control valves (13) is controlled by an assigned individual compensator (19) and the system pressure is controlled by a system compensator (5).

7. The method according to claim 6, characterized in that the differential pressure of the synchronous compensator (33) is set to a somewhat lower value than the differential pressure of the system compensator (5).

8. The method according to claim 6, characterized in that the pressure difference of the synchronous compensator (33) is set to the pressure difference of the individual compensators (19) or higher.

9. The method according to claim 5, characterized in that the system of valves and pumps is dimensioned such that at the maximum possible volumetric flow demand the maximum synchronous pressure (X_{syn}) does not exceed the pretensioning force of the centering springs of the valve spools (15).

10. The method according to claim 2, characterized in that supply of the correction signal (X_{syn}) to preferred consumers is stopped.

11. A hydraulic system which can be operated according to the method according to claim 1 and which has:
a) at least one supply device, in particular a hydraulic pump (3, 9) which supplies different hydraulic consumers;
b) one adjustable metering orifice (17) assigned to each consumer in order to supply a volumetric flow of pressurized fluid which is dependent on the size of the opening of this orifice, and
c) a synchronous device (33, 35) in order to produce, when the pressure difference on at least one metering orifice (17) drops below a setpoint, a correction signal (X_{syn}), depending on whose signal value the size of the opening of all metering orifices (17) can be synchronously reduced.

12. The hydraulic system according to claim 11, characterized in that there is a synchronous compensator (33) which produces the synchronous pressure (X_{syn}) as the correction signal and which is supplied on the one hand with the pump pressure (Pₚᵤ) and on the other with the highest load pressure (L_{STB}) of the system, plus the force of its control spring (37).

13. The hydraulic system according to claim 12, characterized in that for control of the supply of the consumers there are proportional directional control valves (13) whose valve spools (15) can be triggered hydraulically for changing the metering orifices (17) by sensor pressure (X . . . ), and that the synchronous pressure (X_{syn}) can be connected by way of the synchronous channel (35) in parallel to each face side of the valve spools (15) of all directional control valves (13).

14. The hydraulic system according to claim 13, characterized in that selector valves (43) or a hydraulic logic circuit (FIG. 6) by way of which a sensor pressure (X . . . ) or a synchronous pressure (X_{syn}) can be supplied to the respective face sides of the valve spools (15) are assigned to each directional control valve (13).
